(19) United States
(12) Patent Application Publication
(10) Pub. No.: US 2008/0195349 A1
(43) Pub. Date: Aug. 14, 2008

(54) Calorimetric Measuring Device

(75) Inventors: Lieve Hoflack, Heers (BE); Peter Van Gerwen, Keerbergen (BE); Katarina Verhaegen, Bertem (BE); Roeland Papen, Half Moon Bay, CA (US)

Correspondence Address: CLARK & ELBING LLP, 101 FEDERAL STREET, BOSTON, MA, 02110, US

(73) Assignee: Vivactis N.V., Heverlee (BE)

(21) Appl. No.: 11/912,281

(22) PCT Filed: Apr. 21, 2006
(86) PCT No.: PCT/BE2006/000039

§ 371 Date: Oct. 22, 2007

Related U.S. Application Data
(60) Provisional application No. 60/673,415, filed on Apr. 21, 2005.

(51) Int. Cl. G01K 17/00; G01N 25/48

(52) U.S. Cl. 702/136; 374/31; 374/E17.001

(57) ABSTRACT

A calorimetric measuring device as subject of the present invention, for qualitative or quantitative analysis of the enthalpy of a buffer and one or more reagents, comprises a first open calorimeter for to receiving a buffer solution and one or more reagents, and a second open calorimeter for receiving a reference buffer solution. The calorimetric measuring device further comprises a means for registration of a signal being function of the temperature difference between the first open calorimeter and the second open calorimeter.

### TECHNICAL FIELD OF THE INVENTION

The present invention relates to calorimetric measuring devices, also called calorimetric integrators, more particularly to calorimetric measuring devices for qualitative or quantitative analysis of transient processes such as enzymatic turnover, metabolic assays or binding assays.

### BACKGROUND OF THE INVENTION

In the art, it is known to use temperature related curves in function of time, the temperature related curves being measured during a number of experiments using closed calorimeters, to calculate reaction parameters of endothermic and exothermic reactions, such as e.g. enzymatic turnover. Out of the curves thus obtained during the conduct of experiments being part of the well-defined design of experiments (DOE), reaction parameters or characteristics of the transient process, e.g. enzymatic reaction can be calculated, e.g. the catalytic constant Kcat or Michaelis-Menten constant Km.

A disadvantage of such methods is that the concentration of reagents can only be obtained indirectly by using kinetic data and parameters.

As it is difficult, if not impossible, to deduce these concentrations of substrate and products directly from the temperature related curves, the calculated reaction parameters are usually an estimation of the real reaction parameters, which may suffer to some extent from inaccuracy.

An other disadvantage of the temperature related curves used to define the reaction parameters, is the S/N ratio. For some reactions, e.g. relatively slow reactions (low Kcat) or reactions providing a relatively small power production (low delta H), the influence of the noise (N) on the measured signal (S) may be too large to provide sufficient reliability.

### SUMMARY OF THE INVENTION

It is an object of the present invention to provide an improved calorimetric measuring device, also called calorimetric integrator, and a method for qualitative or quantitative analysis of the enthalpy of a buffer and one or more reagents during conversion from one or more reagents into one or more products, more particularly during transient processes, e.g. enzymatic turnover, metabolic processes or binding processes.

The above objective is accomplished by a method and device according to the present invention.

According to a first object of the present invention, a calorimetric measuring device for qualitative or quantitative analysis of the enthalpy of a buffer and one or more reagents as subject of the present invention, comprises a first open calorimeter for to receiving a buffer solution and one or more reagents, and a second open calorimeter for receiving a reference buffer solution is provided. The calorimetric measuring device further comprises a means for registration of a signal being function of the temperature difference between the first open calorimeter and the second open calorimeter.

According to embodiments of the present invention, a calorimetric measuring device furthermore may comprise means for automatically calculating reaction parameters from registered said signal.

According to embodiments of the present invention, a calorimetric measuring device may be suitable for qualitative or quantitative analysis of the enthalpy of a buffer and one or more reagents during conversion of at least one reagent into products using enzymatic turnover, wherein the first open calorimeter is adapted to receive a buffer solution, an enzyme and at least one other reagent. According to embodiments of the present invention, one of said calculated reaction parameters may be Kcat of the enzyme. According to embodiments of the present invention, one of the calculated reaction parameters may be Km of the enzyme. According to embodiments of the present invention, one of the calculated reaction parameters may be the total amount of each of the products provided by the enzymatic turnover. According to embodiments of the present invention, one of the calculated reaction parameters may be the change of concentration of at least one of the reagents due to the enzymatic turnover. According to embodiments of the present invention, one of the calculated reaction parameters may be the change of concentration of each of the reagents due to the enzymatic turnover.

According to embodiments of the present invention, a calorimetric measuring device as subject of the present invention may be used as a concentration sensor for measuring the concentration of at least one of the one or more reagents. According to embodiments of the present invention, the use may be the use as a concentration sensor for measuring the concentration of at least one of the one or more reagents in real time.

According to a second object of the present invention, a method of qualitative or quantitative analysis of the enthalpy of a buffer and one or more reagents during conversion from one or more reagents into one or more products is provided. This method comprises the steps of
Providing a first volume V1 of a buffer solution into a first open calorimeter;
Providing a first volume V1 of the buffer solution into a second open calorimeter;
Providing a second volume V2 comprising one or more reagents and possibly buffer solution into the first open calorimeter;
Providing a second volume V2 of buffer solution into the second open calorimeter;
Registering a signal related to the temperature difference between the first open calorimeter and the second open calorimeter in function of time.

According to embodiments of the present invention, a method of qualitative or quantitative analysis of the enthalpy of a buffer and one or more reagents during conversion from one or more reagents into one or more products may further comprise automatically calculating reaction parameters from the signal.

According to embodiments of the present invention, the conversion may be an enzymatic turnover, the reagents comprise an enzyme and at least one other reagent.

According to embodiments of the present invention, one of the calculated reaction parameters may be Kcat of the enzyme. According to embodiments of the present invention, one of the calculated reaction parameters may be Km of the enzyme. According to embodiments of the present invention, one of the calculated reaction parameters may be the total amount of each of the products provided by the enzymatic turnover. According to embodiments of the present invention, one of the calculated reaction parameters may be the change of concentration of at least one of the reagents due to the enzymatic turnover. According to embodiments of the present invention, one of the calculated reaction parameters may be the change of concentration of each of the reagents due to the enzymatic turnover.

According to embodiments of the present invention, the conversion may be a metabolic assay. According to embodiments of the present invention, the conversion may be a cellular metabolic assay. According to embodiments of the present invention, the conversion may be a metabolic assay using micro-organisms.

According to embodiments of the present invention, the conversion may be a binding assay.

According to another object of the present invention, a computer program product for executing any of the methods as subject of the present invention when executed on a computing device associated with a calorimetric measuring device is provided. The method comprising the steps of
Providing a first volume V1 of a buffer solution into a first open calorimeter;
Providing a first volume V1 of the buffer solution into a second open calorimeter;
Providing a second volume V2 comprising one or more reagents and possibly buffer solution into the first open calorimeter;
Providing a second volume V2 of buffer solution into the second open calorimeter;
Registering a signal related to the temperature difference between the first open calorimeter and the second open calorimeter in function of time.

The present invention also relates to a machine readable data storage device storing the computer program product as set out above, and/or the transmission of such computer program product over a local or wide area telecommunications network.

The terms “carrier medium” and “computer readable medium” as used herein refer to any medium that participates in providing instructions to a processor for execution. Such a medium may take many forms, including but not limited to, non-volatile media, volatile media, and transmission media. Non-volatile media includes, for example, optical or magnetic disks, such as a storage device which is part of mass storage. Volatile media includes dynamic memory such as RAM. Transmission media include coaxial cables, copper wire and fiber optics, including the wires that comprise a bus within a computer. Transmission media can also take the form of acoustic or light waves, such as those generated during radio wave and infra-red data communications.

Common forms of computer readable media include, for example a floppy disk, a flexible disk, a hard disk, magnetic tape, or any other magnetic medium, a CD-ROM, any other optical medium, punch cards, paper tapes, any other physical medium with patterns of holes, a RAM, a PROM, an EPROM, a FLASH-EPROM, any other memory chip or cartridge, a carrier wave as described hereafter, or any other medium from which a computer can read.

Various forms of computer readable media may be involved in carrying one or more sequences of one or more instructions to a processor for execution. For example, the instructions may initially be carried on a magnetic disk of a remote computer. The remote computer can load the instructions into its dynamic memory and send the instructions over a telephone line using a modem. A modem local to the computer system can receive the data on the telephone line and use an infrared transmitter to convert the data to an infrared signal. An infrared detector coupled to a bus can receive the data carried in the infra-red signal and place the data on the bus. The bus carries data to main memory, from which a processor retrieves and executes the instructions. The instructions received by main memory may optionally be stored on a storage device either before or after execution by a processor. The instructions can also be transmitted via a carrier wave in a network, such as a LAN, a WAN or the internet. Transmission media can take the form of acoustic or light waves, such as those generated during radio wave and infrared data communications. Transmission media include coaxial cables, copper wire and fibre optics, including the wires that form a bus within a computer.

Accordingly, the present invention includes a computer program product which provides the functionality of any of the methods according to the present invention when executed on a computing device. Further, the present invention includes a data carrier such as a CD-ROM or a diskette which stores the computer product in a machine readable form and which executes at least one of the methods of the invention when executed on a computing device. Nowadays, such software is often offered on the Internet or a company Intranet for download, hence the present invention includes transmitting the printing computer product according to the present invention over a local or wide area network. The computing device may include one of a microprocessor and an FPGA.

It is an advantage of the calorimetric measuring device as subject of the present invention and of the method of qualitative or quantitative analysis of the enthalpy of a buffer and one or more reagents during conversion from one or more reagents into one or more products that a sufficient S/N ratio is obtained for providing reliable measurements Preferably, the S/N ratio is better than with prior art calorimetric measuring devices and methods. It is an advantage of some of the embodiments of the present invention that more accurate reaction parameters can be calculated from the obtained temperature related curves.

It is an advantage of embodiments of the present invention that the calorimetric measuring device can be used as an analytical tool for measuring the concentration of one or more products. It is an advantage of embodiments of the present invention that the calorimetric measuring device can be used as an analytical tool for measuring the concentration of one or more products in real time.

It is an advantage of embodiments of the present invention that the calorimetric measuring device can be used for measuring a broader range of possible conversions. These calorimetric measuring devices of the present invention are useful in the case where the reagent conversion is extremely slow (Kcat very low), and/or in the case where this conversion is accompanied by very small power production or consumption (delta H very low)

Particular and preferred aspects of the invention are set out in the accompanying independent and dependent claims. Features from the dependent claims may be combined with features of the independent claims and with features of other dependent claims as appropriate and not merely as explicitly set out in the claims.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 shows a baseline shift being measured using a calorimetric measuring device as subject of embodiments of the present invention.

FIG. 2. shows a summary of baseline shifts of maltose, both in PBS 30 buffer and in water, in function of the final concentration of maltose.

FIG. 3 shows a monitored gluco-amylase turnover using a calorimetric measuring device as subject of embodiments of the present invention.

FIG. 4 shows a simulated amylosucrase turnover using a calorimetric measuring device as subject of embodiments of the present invention.

FIG. 5 illustrates a microtiterplate with a calorimetric measurement device according to embodiments of the present invention, in top view (left hand side) and in cross-section (right hand side).

FIG. 6 shows a configuration of processing system for executing a computer program product for executing any of the methods as subject of the present invention when associated with a calorimetric measuring device.

In the different figures, the same reference signs refer to the same or analogous elements.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “coupled” should not be interpreted as being restricted to direct connections only. Thus, the scope of the expression “a device A coupled to a device B” should not be limited to devices or systems wherein an output of device A is directly connected to an input of device B. It means that there exists a path between an output of A and an input of B which may be a path including other devices or means.

The following terms are provided solely to aid in the understanding of the invention. These definitions should not be construed to have a scope less than understood by a person of ordinary skill in the art.

The terms “open calorimetry” refers to the use of open calorimeters. The term “open calorimeter” refers to (partially) open calorimeters in which partial equilibriums can be settled between at least 2 phases, e.g. water and water vapour, enclosed or open to the environment.

The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims.

The basic idea of the invention is to use open calorimetry to both intensify the signal and increase information content when performing calorimetric experiments. Through a good design of experiments (DOE), several parameters and data such as e.g. enzymatic kinetic data such as e.g. Michaelis-Menten constant Km, catalytic constant Kcat, product/substrate inhibition, delta H, binding data such as e.g. affinity constants and delta H, or metabolic data such as e.g. basal metabolism, activated metabolism, repressed metabolism as concentrations of metabolites such as e.g. ethanol, lactate and glucose can be derived through integration, exclusion or mathematical deduction from comparison of temperature related curves in function of time. These temperature related curves are obtainable due to:
transient process (e.g. enzymatic turnover, metabolic process, binding process);
the baseline shift related to product formation and/or reagent consumption.

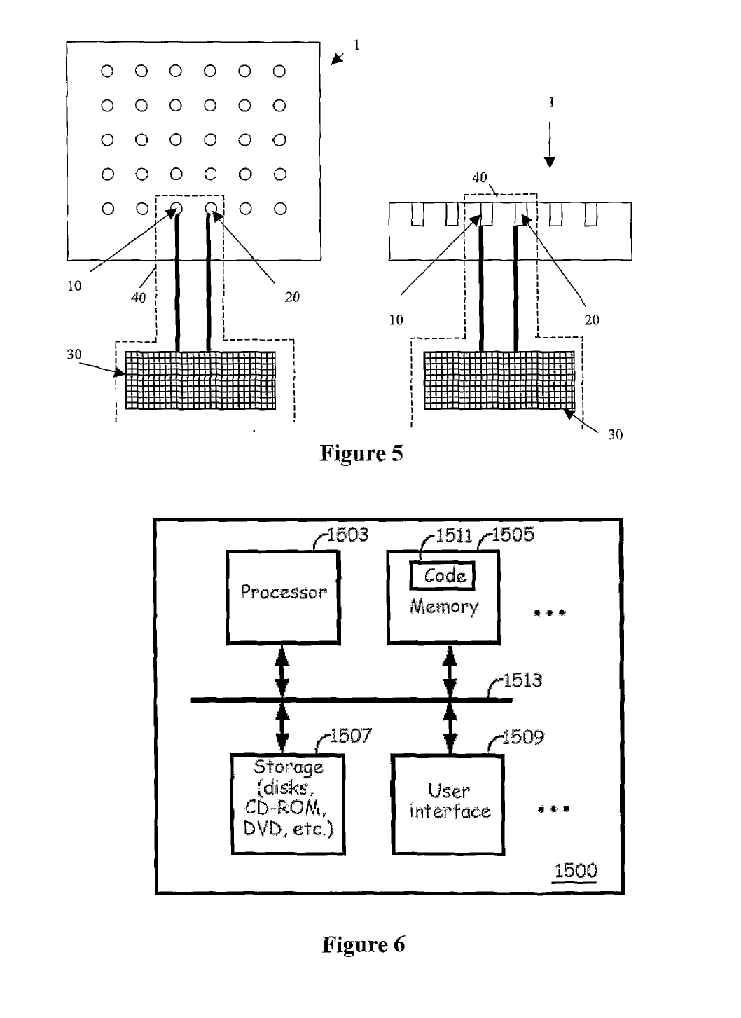

The present invention, as illustrated in FIG. 5, uses the differential temperature between two open calorimeters, for example provided on a microtiterplate 1, one calorimeter called the reference calorimeter 10, the other the test calorimeter 20, both being part of the calorimetric measuring device 40 as subject of the present invention. The reference calorimeter 10 contains a first volume of a buffer solution e.g. a volume V1, and the test calorimeter 20 contains the same first volume V1 of buffer solution. As an example, but not limited thereto, the buffer solution may be PBS or water. After thermal stabilization of both calorimeters 10, 20, the difference in temperature between the two calorimeters 10, 20 is determined by means of a measurement device 30, and this difference in temperature is taken as zero-baseline.

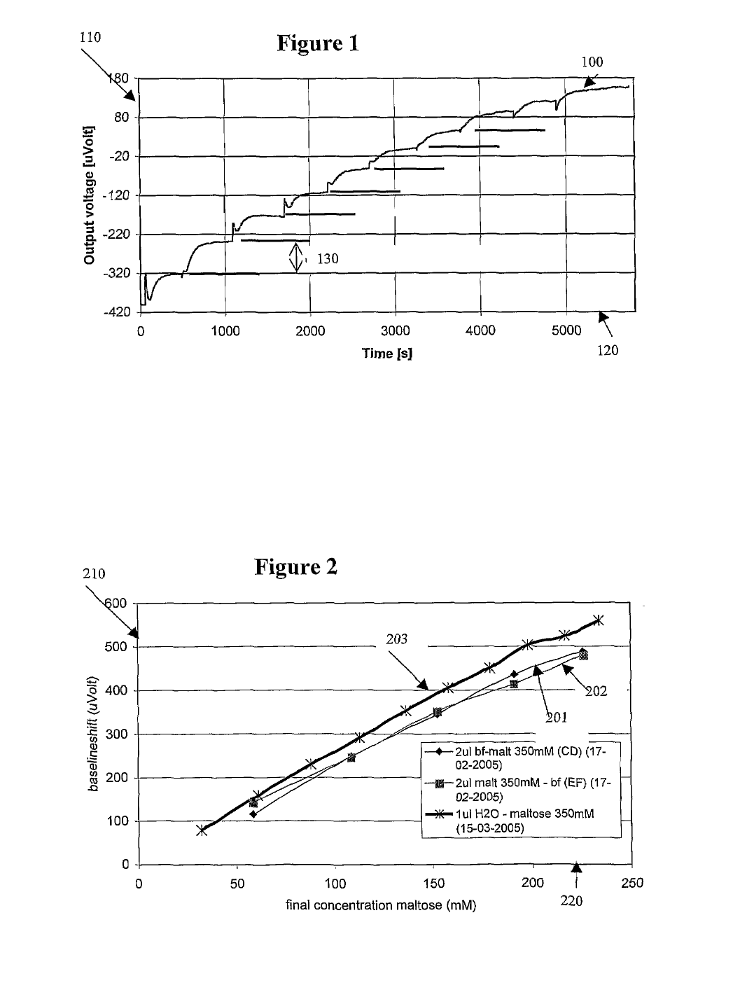

In at least one and possibly a plurality of subsequent steps, a pre-defined second volume V2 of reagent, e.g. a substrate for an enzyme or any other product, e.g. solution of maltose (see graphs of FIG. 1 and FIG. 2) is added to the first volume V1 of buffer solution in the test calorimeter 20. For each addition of reagent into the test calorimeter 20, an identical amount V2 of pure buffer solution is added into the reference calorimeter 10. It is to be noted that the second volumes V2 added during a plurality of subsequent steps do not need to be the same, i.e. may for example be a second volume V2 and a third volume V3, the second and the third volume being different. However, volumes added into the test calorimeter 20 and the reference calorimeter 10 for every step are the same, i.e. in a second step in both a second volume V2 may be added, and in a subsequent third step in both calorimeters 10,20 a third volume V3 may be added.

The temperature related curve reflecting the temperature difference between the reference open calorimeter 10 and the test open calorimeter 20 may for example be obtained by conversion of a measurement of an electrical tension, expressed in μV. As an example, a baseline shift 130 is shown in FIG. 1 which results from repetitive addition of 1 microliter of 350 mM maltose in a PBS buffer. The temperature related curve 100 shows in vertical axis 110 a temperature related value, in the case illustrated the voltage difference (in μV) measured between the two open calorimeters, and reflects the temperature difference between the two open calorimeters 10, 20 in function of time (in seconds) in horizontal axis 120.

The stepwise temperature related curve 100 that results from this experiment, i.e. subsequent addition of 1 microliter (ul) of 350 mM maltose into the test calorimeter 10 while adding 1 microliter of PBS buffer in the reference calorimeter 20, is due to the difference in amount of dissolved molecules in the test calorimeter 20 with respect to the reference calorimeter 10.

FIG. 2. shows a summary of baselineshifts (in vertical axis 210 in μV) of maltose, both in NaOAc-buffer (graphs 201 and 202) and in water (graph 203), in function of the final concentration of maltose (in horizontal axis 220 expressed in mM). One can notice a linear relationship between final concentration of maltose and baselineshift of about 2.3 μV/mM. More in particular, curve 201 shows the baseline shift—maltose concentration relation in two open calorimeters or “wells” 10 ul of NaOAc-buffer is provided. In the first well or open calorimeter, being the reference well or reference open calorimeter, five times 2 ul of this buffer is added, whereas simultaneously, in the second test well or test open calorimeter, five times 2 ul of 350 mM maltose is provided. After each addition of 2 ul buffer in the reference well and 2 ul maltose in the test well, sufficient time is provided to have the baseline reaching its equilibrium for that particular concentration of maltse; The baseline shift was measured after each of the five additions of 2 ul maltose or buffer and set out in the graph 201, being “2 ul bf-malt 350 mM”. This test was repeated to provide curve 202 shows the baseline shift—maltose concentration relation for “2 ul malt 350 mM−bf”. Curve 203 named “1 ul H2O-malt 350 mM” shows the baseline shift—maltose concentration relation when using water as buffer. A similar test setup was used, using however 10 additions of 1 ul water in the reference well and 1 ul 350 mM maltose in the test well.

When the experiment is performed in reversed mode, e.g. an ‘unknown’ amount or concentration of molecules is added or produced in the test calorimeter 20, the signal that is recorded by means of the measurement device 30 will quantify this amount or concentration. The calorimetric measuring device 40 in this case serves as a concentration sensor. If the baseline shift is known for the different products and reagents, one can use this method as an analytical tool to measure the concentration of reagents and/or products in real time. Hence the calorimetric measuring device 40 as subject of the present invention can be used as an analytical tool.

This concentration related part of the output can be modelled by a simple relationship. Given a solution with n different molecules Ai, each with its own concentration [Ai] and its baseline shift constant bi, the temperature related value, e.g. output voltage is the sum given by

$$V = {\sum }_{i = 1}^{n} {b}_{i} [ {A}_{i} ]$$

In case of e.g. enzymatic turnover studies or cellular assays, reagents are converted into products, i.e. products are produced and reagents are consumed. This turnover can be monitored by acquisition of a temperature related time curve, e.g. the power (μV) versus time curve. Such curve, being a representation of a temperature related curve in function of time, can be used to extract the kinetics of the reagents, e.g. enzyme. However, it was seen that when using open calorimetry, in accordance with the present invention, the effect of the change in concentration of reagents and products is also apparent in the temperature related curve, in contrast with closed calorimeter temperature related curves, showing only the effect of the temperature change due to the reaction of the reagents, e.g. enzyme, without reflection of the difference in concentration of any product.

Thus, looking at the temperature related curves measured between two open calorimeters as subject of the present invention, one open calorimeter being the reference open calorimeter 10, the other open calorimeter being the test calorimeter 20, one can dissect it into a first signal coming from the turnover power, and a second signal emanating from the change in calorimeter content. If the subsequent data analysis takes these two elements into account, one can extract the true turnover characteristics of the reagents, e.g. enzyme (e.g. Kcat and Km), and the product build-up/reagents conversion. These parameters can be automatically calculated from the obtained signal, e.g. by means of appropriate computer programs.

The presence of the signal part relating to the product build-up/reagents conversion serves as a measured extra calorimetric difference between reference calorimeter 10 and test calorimeter 20. So, when looking at the S/N ratio, the presence of this extra calorimetric difference between the two calorimeters will positively influence this ratio. In the temperature related curves below, is shown:

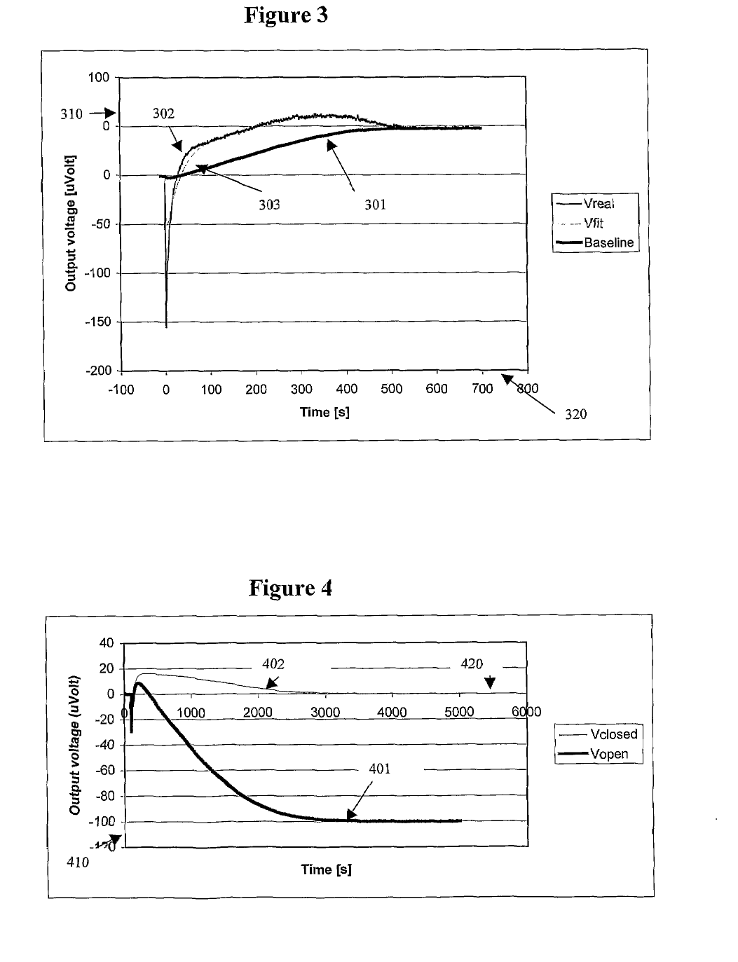

monitored gluco-amylase (FIG. 3)

simulated amylosucrase (FIG. 4)

FIG. 3. shows a measurement of enzymatic activity of glucoamylase on maltose. Enzyme concentration was about 66.7 μM, maltose concentration was 27 mM. The baseline (“baseline”) and its shift over time is indicated by the curve 301. The curve 303 (called “Vfit”) is a fit to the measured curve 302 (called “Vreal”), using Km=2.61 mM, kcat=1.22 s⁻¹ and ΔH=3.89 kJ/mol exothermic, which reaction parameters can be automatically calculated from the measured curve 302. This calculation is based on a fitted Michaelis-Menten model. The curves show in vertical axis 310 the temperature related value, e.g. tension (μV) measured between the test open calorimeter 20 and the reference calorimeter 10, as set out in function of time (seconds) along the horizontal axis 320.

FIG. 4. shows a simulation 401 of an interaction with Km=38.7 mM, kcat=15 s⁻¹, amylosucrase enzyme concentration being 6.7 μM, substrate concentration being 100 mM sucrose and exothermic reaction enthalpy being 2.1 kJ/mol. The resulting product is amylose. The signal “Vclosed” 402 is the signal that would be measured with the calorimeters in closed mode, i.e. no air present in the closed calorimeters. In open calorimetry, the base-line shift amplifies the signal by a factor of more than five, due to the substrate shift of 2 μV/mM, product shift of 1 μV/mM and enzyme shift of 1 μV/mM. The maximum output signal of curve 401 is about −100 μV, whereas the maximum output of the closed calorimeter curve would only be about 18 μV.

Again, the curves of FIG. 4 show in vertical axis 410 the tension (μV) measured over the calorimeters 10, 20, set out in function of time (seconds) along the horizontal axis 420.

It is clear that the change in baseline, or baseline shift, reflects the difference in enthalpy during enzymatic turnover. The enzymatic turnover signal and the change in this baseline add up to form the full measurement signal.

If one is interested in product formation over time, the enzymatic turnover power is integrated. The change in baseline can be seen as a direct measure of the product formation. Having these two in one graph doubles the information content and increases the signal (as the two add up).

It can be stated that, in accordance with the present invention, the open calorimeter technique has been used both as:
a real-time technology to visualize the reagent, e.g. enzymatic, power production/consumption on the one hand and the real-time change in enthalpy on the other hand; and
as a sort of integrator technology to visualize difference in enthalpy after conversion has taken place.

An increase of S/N ratio is obtained, and hence the uncertainty to be taken into account when calculating reaction parameters out of the temperature related curve is reduced.

The latter might be very useful in the case where the reagent conversion, e.g. enzymatic conversion, is extremely slow (Kcat very low), and/or in the case where this conversion is accompanied by very small power production (delta H very low). In these cases, the signal part provided by the reaction (as would be obtained in a closed calorimeter temperature related curve) is relatively small as compared to the noise.

The present invention includes that these ideas can also be applied to metabolic assays (e.g. cellular or micro-organisms) and binding assays.

The above-described method embodiments may be implemented in a computing device or processing system 1500 such as shown in FIG. 6. FIG. 6 shows one configuration of processing system 1500 that includes at least one programmable processor 1503, such as a conventional microprocessor of which a Pentium III (®) processor supplied by Intel Corp. USA is only an example, coupled to a memory subsystem 1505 that includes at least one form of memory, e.g., RAM, ROM, and so forth. A storage subsystem 1507 may be included that has at least one disk drive and/or CD-ROM drive and/or DVD drive. In some implementations, a display system, a keyboard, and a pointing device may be included as part of a user interface subsystem 1509 to provide for a user to manually input information. Ports for inputting and outputting data also may be included. More elements such as network connections, interfaces to various devices, and so forth, may be included, but are not illustrated in FIG. 6. The various elements of the processing system 1500 may be coupled in various ways, including via a bus subsystem 1513 shown in FIG. 6 for simplicity as a single bus, but will be understood to those in the art to include a system of at least one bus. The memory of the memory subsystem 1505 may at some time hold part or all (in either case shown as 1511) of a set of instructions that when executed on the processing system 1500 implement the step(s) of the method embodiments described herein. Thus, while a processing system 1500 such as shown in FIG. 6 is prior art, a system that includes the instructions to implement aspects of the present invention is not prior art, and therefore FIG. 6 is not labeled as prior art.

It is to be noted that the processor 1503 or processors may be a general purpose, or a special purpose processor, and may be for inclusion in a device, e.g., a chip that has other components that perform other functions. Thus, one or more aspects of the present invention can be implemented in digital electronic circuitry, or in computer hardware, firmware, software, or in combinations of them. Furthermore, aspects of the invention can be implemented in a computer program product tangibly embodied in a carrier medium carrying machine-readable code for execution by a programmable processor. Method steps of aspects of the invention may be performed by a programmable processor executing instructions to perform functions of those aspects of the invention, e.g., by operating on input data and generating output data.

It is to be understood that although preferred embodiments, specific constructions and configurations, as well as materials, have been discussed herein for devices according to the present invention, various changes or modifications in form and detail may be made without departing from the scope and spirit of this invention.

The invention can be used to monitor yeast/bacteria for the production of alcohol or ethanol. Different yeast mutants can be screened for optimal performance in terms of metabolic performance and alcohol/ethanol production. By adequate software the registered signal can be dissected into real-time metabolic performance on one hand, and the total alcohol/ethanol concentration on the other hand. This is useful in the discovery and/or optimization of yeast/bacterial strains for the research and production of (bio)-ethanol or food/beverage industry.

Also at the level of enzymatic conversion to ethanol the above can be applied. Cellular assays can be designed to monitor the metabolites (e.g. glucose, O2, CO2, lactate, ethanol, alcohol . . . ). Whenever these come into the extracellular medium, the change of baseline due to the change in concentration can be applied to monitor the metabolic activity/state of the cells.

1. Calorimetric measuring device (40) for qualitative or quantitative analysis of the enthalpy of a buffer and one or more reagents, said calorimetric measuring device (40) comprising a first open calorimeter (20) for to receiving a buffer solution and one or more reagents, and a second open calorimeter (10) for receiving a reference buffer solution, said calorimetric measuring device (40) further comprising a means (30) for registration of a signal being function of the temperature difference between said first open calorimeter (20) and said second open calorimeter (10).

2-25. (canceled)

26. Calorimetric measuring device as in claim 1, wherein said calorimetric measuring device furthermore comprises means for automatically calculating reaction parameters from registered said signal.

27. Calorimetric measuring device as in claim 26, wherein said calorimetric measuring device is suitable for qualitative or quantitative analysis of the enthalpy of a buffer and one or more reagents during conversion of at least one reagent into products using enzymatic turnover, wherein said first open calorimeter is adapted to receive a buffer solution, an enzyme and at least one other reagent.

28. Calorimetric measuring device as in claim 27, wherein one of said calculated reaction parameters is Kcat of said enzyme.

29. Calorimetric measuring device as claim 27, wherein one of said calculated reaction parameters is Km of said enzyme.

30. Calorimetric measuring device as in claim 27, wherein one of said calculated reaction parameters is the total amount of each of said products provided by said enzymatic turnover.

31. Calorimetric measuring device as in claim 27, wherein one of said calculated reaction parameters is the change of concentration of at least one of said reagents due to said enzymatic turnover.

32. Calorimetric measuring device as in claim 27, wherein one of said calculated reaction parameters is the change of concentration of each of said reagents due to said enzymatic turnover.

33. A method of qualitative or quantitative analysis of the enthalpy of a buffer and one or more reagents during conversion from one or more reagents into one or more products, comprising
Providing a first volume V1 of a buffer solution into a first open calorimeter;
Providing a first volume V1 of the buffer solution into a second open calorimeter;
Providing a second volume V2 comprising one or more reagents and possibly buffer solution into said first open calorimeter;
Providing a second volume V2 of buffer solution into said second open calorimeter; and
Registering a signal related to the temperature difference between said first open calorimeter and said second open calorimeter in function of time.

34. The method of qualitative or quantitative analysis of the enthalpy of a buffer and one or more reagents during conversion from one or more reagents into one or more products according to claim 33, wherein said method further comprises automatically calculating reaction parameters from said signal.

35. The method of qualitative or quantitative analysis of the enthalpy of a buffer and one or more reagents during conversion from one or more reagents into one or more products according to claim 34, wherein said conversion is an enzymatic turnover, said reagents comprise an enzyme and at least one other reagent.

36. The method of qualitative or quantitative analysis of the enthalpy of a buffer and one or more reagents during conversion from one or more reagents into one or more products according to claim 35, wherein one of said calculated reaction parameters is Kcat of said enzyme.

37. The method of qualitative or quantitative analysis of the enthalpy of a buffer and one or more reagents during conversion of one or more reagents into one or more products according to claim 35, wherein one of said calculated reaction parameters is Km of said enzyme.

38. The method of qualitative or quantitative analysis of the enthalpy of a buffer and one or more reagents during conversion from one or more reagents into one or more products according to claim 35, wherein one of said calculated reaction parameters is the total amount of each of said products provided by said enzymatic turnover.

39. The method of qualitative or quantitative analysis of the enthalpy of a buffer and one or more reagents during conversion from one or more reagents into one or more products according to claim 35, wherein one of said calculated reaction parameters is the change of concentration of at least one of said reagents due to said enzymatic turnover.

40. The method of qualitative or quantitative analysis of the enthalpy of a buffer and one or more reagents during conversion from one or more reagents into one or more products according to claim 35, wherein one of said calculated reaction parameters is the change of concentration of each of said reagents due to said enzymatic turnover.

41. The method of qualitative or quantitative analysis of the enthalpy of a buffer and one or more reagents during conversion from one or more reagents to one or more products according to claims 33, wherein said conversion is a metabolic assay

42. The method of qualitative or quantitative analysis of the enthalpy of a buffer and one or more reagents during conversion from one or more reagents to one or more products according to claim 41, wherein said metabolic assay is a cellular metabolic assay

43. The method of qualitative or quantitative analysis of the enthalpy of a buffer and one or more reagents during conversion from one or more reagents to one or more products according to claim 41, wherein said metabolic assay is a metabolic assay using micro-organisms.

44. The method of qualitative or quantitative analysis of the enthalpy of a buffer and one or more reagents during conversion from one or more reagents to one or more products according to claim 33, wherein said conversion is a binding assay.

45. Computer program product for executing a method of qualitative or quantitative analysis of the enthalpy of a buffer and one or more reagents during conversion from one or more reagents into one or more products, when executed on a computing device associated with a calorimetric measuring device, wherein said method comprises:
Providing a first volume V1 of a buffer solution into a first open calorimeter;
Providing a first volume V1 of the buffer solution into a second open calorimeter;
Providing a second volume V2 comprising one or more reagents and possibly buffer solution into said first open calorimeter;
Providing a second volume V2 of buffer solution into said second open calorimeter; and
Registering a signal related to the temperature difference between said first open calorimeter and said second open calorimeter in function of time.

46. Machine readable data storage device storing a computer program product for executing a method of qualitative or quantitative analysis of the enthalpy of a buffer and one or more reagents during conversion from one or more reagents into one or more products, wherein said method comprises:
Providing a first volume V1 of a buffer solution into a first open calorimeter;
Providing a first volume V1 of the buffer solution into a second open calorimeter;
Providing a second volume V2 comprising one or more reagents and possibly buffer solution into said first open calorimeter;
Providing a second volume V2 of buffer solution into said second open calorimeter; and
Registering a signal related to the temperature difference between said first open calorimeter and said second open calorimeter in function of time.

47. Transmission of a computer program product for executing a method of qualitative or quantitative analysis of the enthalpy of a buffer and one or more reagents during conversion from one or more reagents into one or more products, over a local or wide area telecommunications network wherein said method comprises:
Providing a first volume V1 of a buffer solution into a first open calorimeter;
Providing a first volume V1 of the buffer solution into a second open calorimeter;
Providing a second volume V2 comprising one or more reagents and possibly buffer solution into said first open calorimeter;
Providing a second volume V2 of buffer solution into said second open calorimeter; and
Registering a signal related to the temperature difference between said first open calorimeter and said second open calorimeter in function of time.
